(19) United States
(12) Patent Application Publication
(10) Pub. No.: US 2007/0132756 A1
(43) Pub. Date: Jun. 14, 2007

(54) System and method for aiding spacial orientation for persons using three-dimensional graphical models of large buildings

(76) Inventors: Thomas A. Plocher, Hugo, MN (US); Jeffrey M. Rye, Roseville, MN (US); Rui Zhang, Beijing (CN); Zhaoxia Jin, Shanghai (CN)

Correspondence Address: Kris T. Fredrick, Esq.;Patent Services, Honeywell International Inc., 101 Columbia Road, Morristown, NJ, 07962, US

(21) Appl. No.: 11/299,179

(22) Filed: Dec. 9, 2005

(51) Int. Cl. G06T 17/00

(52) U.S. Cl. 345/420

(57) ABSTRACT

A system and method for aiding spatial orientation of displayed graphical models of structures. A monitor displays the graphical model and an input commands a processor to selectively display the model as a two dimensional model or a three dimensional model. The processor displays selected features such as specific areas of the structure, fire hydrants, elevators, smoke detectors, fire detectors, stairways, and individuals within the structure. The processor selectively changes between a two dimensional model to a three dimensional model over a noticeable period of time. A selected floor is shown as decreased transparency and the remaining floors with increased transparency or it is tinted. A wire frame can highlight the one floor or the entire structure. Exterior features of the structure may be shown. A circular scroll bar controls rotation of the three dimensional structure while maintaining the user's orientation in virtual space.

### FIELD OF THE INVENTION

The present invention relates to graphical displays of models of large buildings. More particularly, the invention relates to a system and method of increasing the situation awareness in selected parts of the building.

### BACKGROUND OF THE INVENTION

Increasingly, three-dimensional (3D) models of large buildings are used in graphical displays to support situation awareness in a variety of domains including firefighting, building security, and HVAC management. For example, a semi-transparent 3D model could be used to provide a birds-eye perspective view of the building, outside looking in, and the location of activated smoke and heat detectors seen in 3D space. From such a display, the firefighter can comprehend the spread of the fire at a glance. This would be particularly useful for viewing the vertical spread between floors of the building.

A 3D model would provide a very intuitive way for the firefighter to visualize a path to the fire and to view the locations of his or her team members. However, users of 3D graphical models of buildings sometimes suffer from disorientation as they view and manipulate the 3D building graphics. Without any special aids, all floors of the building tend to look similar. Also, every building has a “front” or main entrance and an “address side.” Unaided, it is easy for the user to lose track of which floors, by number, are involved in the problem and which is the front or the back of the building. Floors with special problems such as fires, security camera activations and the like need to be highlighted so that it is easy for the user to view another part of the building without losing his or her orientation to the problem floors.

It would be of advantage in the art if a system and method could be provided that would aid users in the spatial orientation of 3D building graphics.

Another advantage would be if the floor or floors of interest to a user could be more prominently displayed than those floors near the floor of interest.

Still another advantage would be if the user could see the floor or floors of interest in a contrasting color compared to adjacent floors.

It would be another advance in the art if a 3D graphic display of a building would take into account distinguishing or unique features for use as landmarks by a user.

Other advantages will appear hereinafter.

### SUMMARY OF THE INVENTION

It has now been discovered that the above and other advantages of the present invention may be obtained in the following manner. Specifically, the present invention provides a system and method for increasing visualization by firefighters and others who need to view a graphic representation of a building quickly and effectively to respond to a situation within the building.

The method and system employs a processor for providing a graphical model of a structure, a monitor for displaying the graphical model, and an input for inputting commands to the processor to selectively display the model as either a two dimensional model or a three dimensional model.

The input further is adapted to command the processor to display selected features of the structure such as specific areas of said structure, but not restricted to, fire hydrants, elevators, smoke detectors, fire detectors, stairways, individuals within said structure, and mixtures thereof. The processor selectively changes the model between a two dimensional model to a three dimensional model over a noticeable period of time such as, by way of example, from less than one second to more than three seconds. All that is necessary is that the change appear at a rate that allows the viewer to observe the continuous transition between 2D and 3D and from 3D to 2D.

The monitor displays the structure model and highlights a particular area, such as one floor, by a wire frame outline or by displaying the structure in semi-transparent form and said one floor is shown as decreased transparency and the remaining floors are shown with increased transparency. One or more floors of that structure that are associated with some condition or state, such as smoke or fire, can be highlighted by tinting with color. These methods, —change degree of transparency, tinting with color, and highlighting with wire frame—may be combined to enhance their effect. Id addition, the entire structure can be shown with a wire frame of its exterior overlaid on the basic semi-transparent graphical rendering of the structure. Distinguishing features of the structure, such as roof lines, annexes, entrances, and the like may also be shown in wire frame.

### BRIEF DESCRIPTION OF THE DRAWINGS

For a more complete understanding of the invention, reference is hereby made to the drawings, in which:

FIG. 1 is a perspective view of a display showing one embodiment of the present invention;

FIG. 2 is a perspective view of a display showing a larger embodiment of the present invention;

FIG. 3 is a perspective view of a display showing still another embodiment of the present invention;

FIG. 4 is a perspective view of a display showing an alternative embodiment of the invention shown in FIG. 1;

FIG. 5 is a perspective view of a display showing another alternative embodiment of the invention shown in FIG. 1;

FIG. 6 is perspective views showing the present invention having acted on the view shown in FIG. 3;

FIG. 7 through FIG. 13 illustrate the present invention used to change a display from 2D to 3D and return; and

FIG. 14 is a perspective representation of another embodiment of the present invention and an illustration of that embodiment control device.

### DETAILED DESCRIPTION OF THE PREFERRED EMBODIMENT

The present invention provides for a system and method that enhances the use of graphic displays of structures such as large buildings. By the term “structure” is meant any construction in which people or physical assets are enclosed. Examples of some “structures” are, as examples and not by way of limitation, hospitals, office buildings, nursing homes, extended care facilities, stores, warehouses, factories and the like.

The graphic display of structures is disclosed in a commonly owned co-pending application entitled System and Method for Rendering Building Spaces, filed Nov. 15, 2005, and having Ser. No. 11/274,443.

The graphical model of the structure is provided by a processor, such as a PC or other similar device capable of manipulating data in this form. The model is displayed on a monitor which is used by the person or persons interested in the model. Examples of these are firefighters, law enforcement officials, medical and emergency responders, security officials, facility operators and the like. Any user having a reason to obtain information about a structure and those people or physical assets within the structure is intended to be within the scope of this invention. Finally there is an input that permits the user to issue commands to the processor to permit various information to be requested and displayed. While a keyboard may be used, the preferred input is a conventional set of buttons or connections that are operated by touch, such as those now used in on site credit card purchases. Haptic or gesture-based input devices, such as those based on capacitive sensors may also be used.

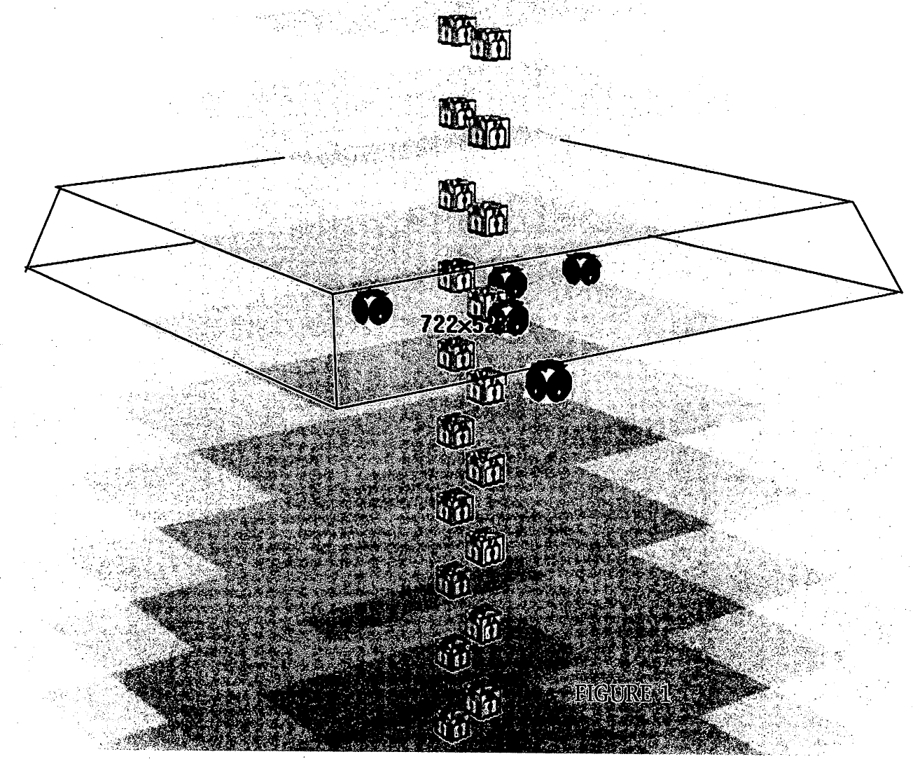

As seen in FIG. 1, one floor of a structure has been selected by a user and is highlighted by placing a wire frame or exterior outline around the selected floor, making it quickly and easily recognized by the user as being the selected floor. Elements such as elevators and fire hoses are identified by icons. The floors are all shown in a semi-transparent gray or neutral shade so that icons are visible. In the case of a fire, the firefighter dispatcher would be immediately able to see the important facts about the selected floor and radio instructions to the responders to save valuable response time. The dispatcher is aided in visualizing the situation on the selected floor by the enhanced wire frame identification.

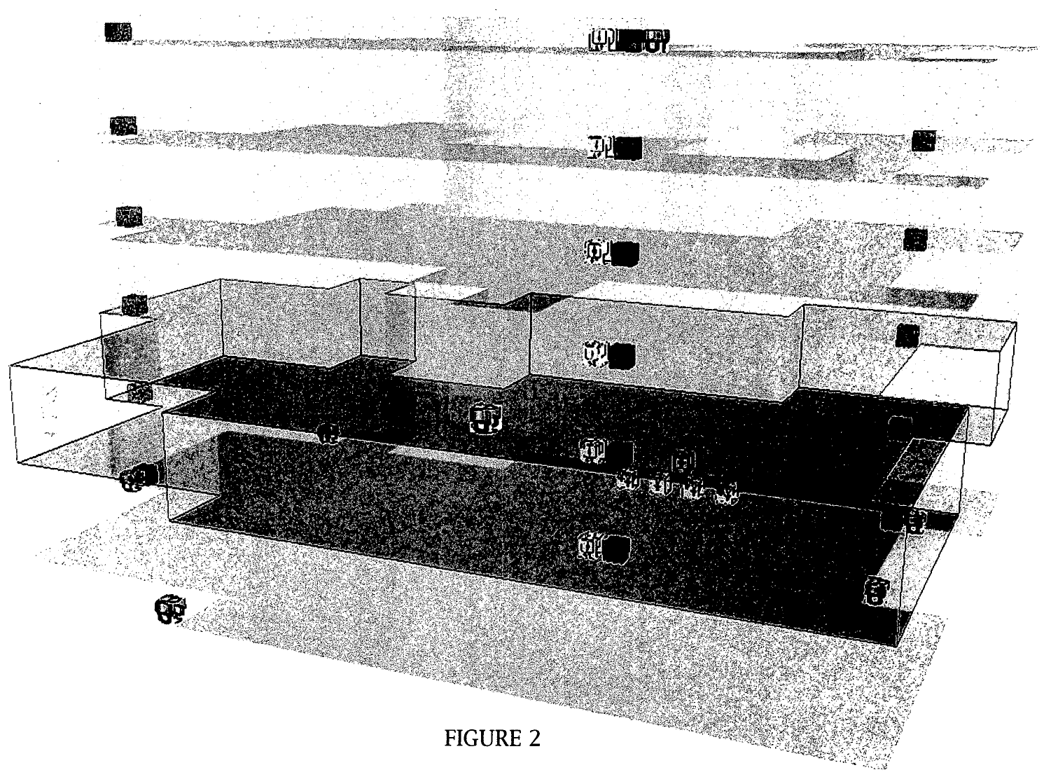

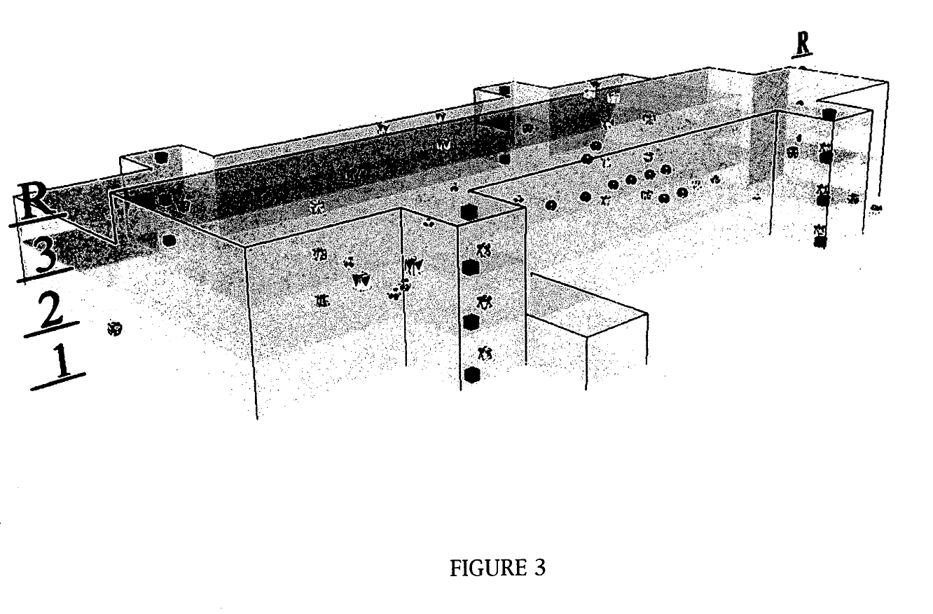

In FIG. 2, a larger structure is shown in which the transparency of the floor of interest is reduced while the transparency of the floors above and below that floor is increased, so that the selected floor stands out in the same manner as that with the wire frame. In FIG. 3. additional indicia showing the floor numbers of a structure is shown. Color may also be used on one or more floors to show a condition or state such as active smoke detectors on the floor, a security breach, etc. Also, all three of these methods—exterior wire frame, modified transparence, and color tinting—may be used in any combination to increase the visibility of a particular floor or floors. Increasing the transparency or using color tinting can also be used to highlight a particular side or sides of the structure, such as the street side, lobby side, etc., to maintain orientation.

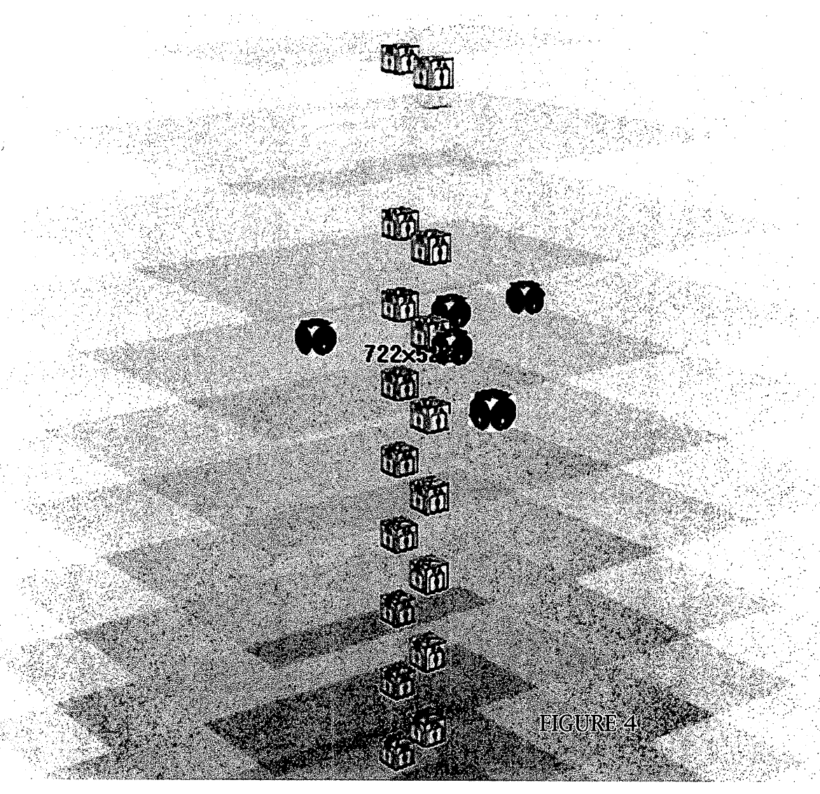

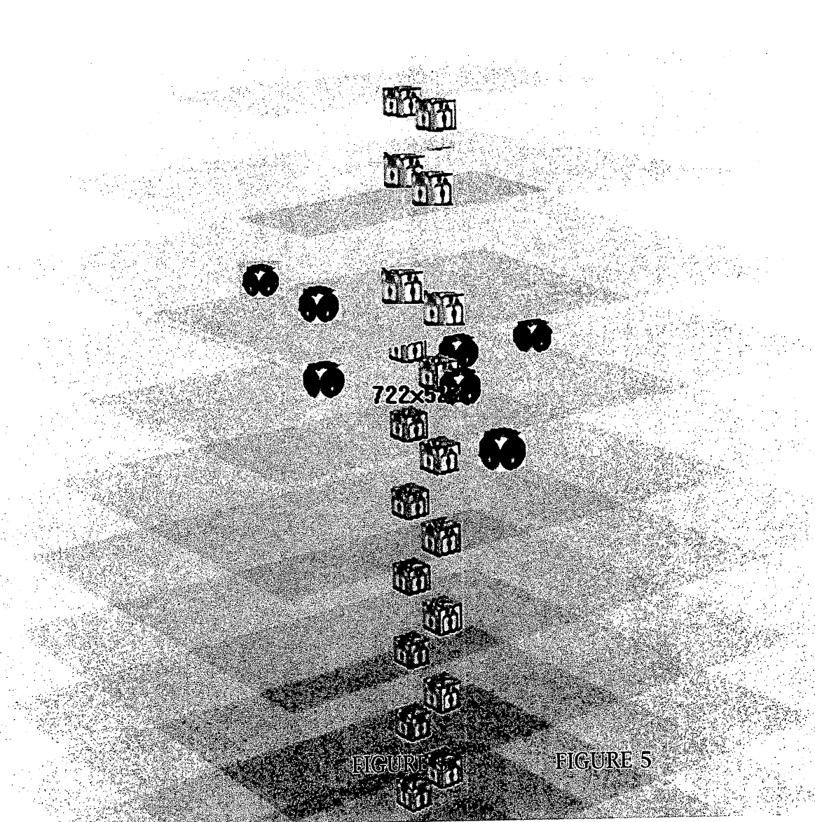

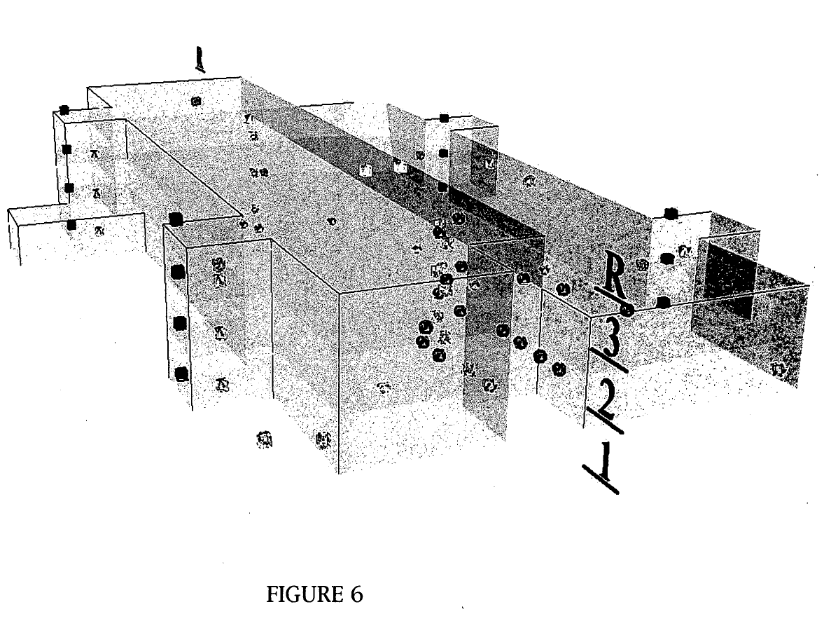

FIGS. 4 and 5 illustrate the situation when objects of interest, shown by the icons, have moved. FIG. 6 illustrates the structure of FIG. 3 after it has been rotated. The corners, stairwells, entryways, different roof levels and number of floors in various parts of the structure stand out because they are sown in wire frame and it is much more informative. The unobtrusive wire frame lines are rendered in a pale gray so as not to noticeably occlude the icons embedded in the building display. The lines make any unique exterior features of the building, such as multilevel roofs, annexes, and the like stand out visually—Such features are natural orientation landmarks for the user.

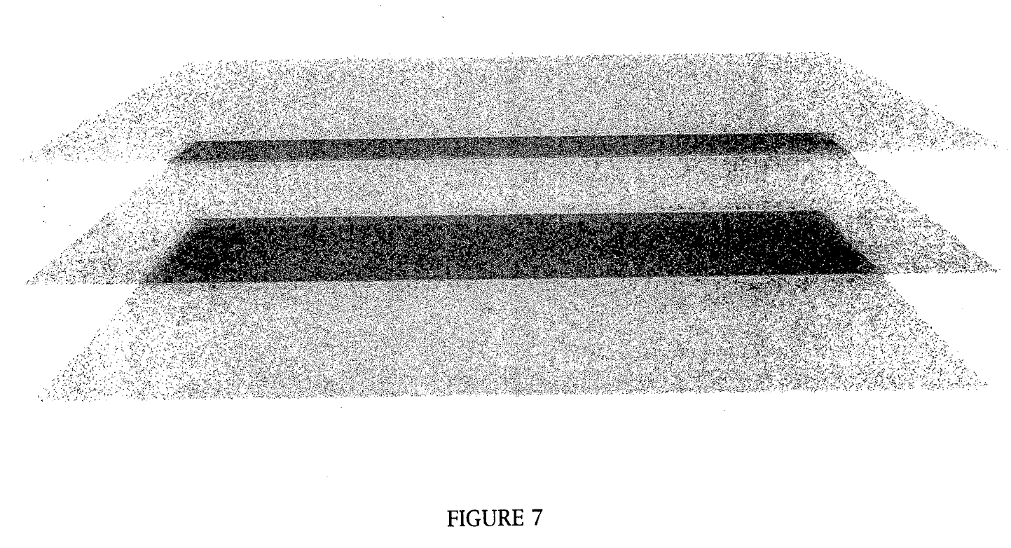

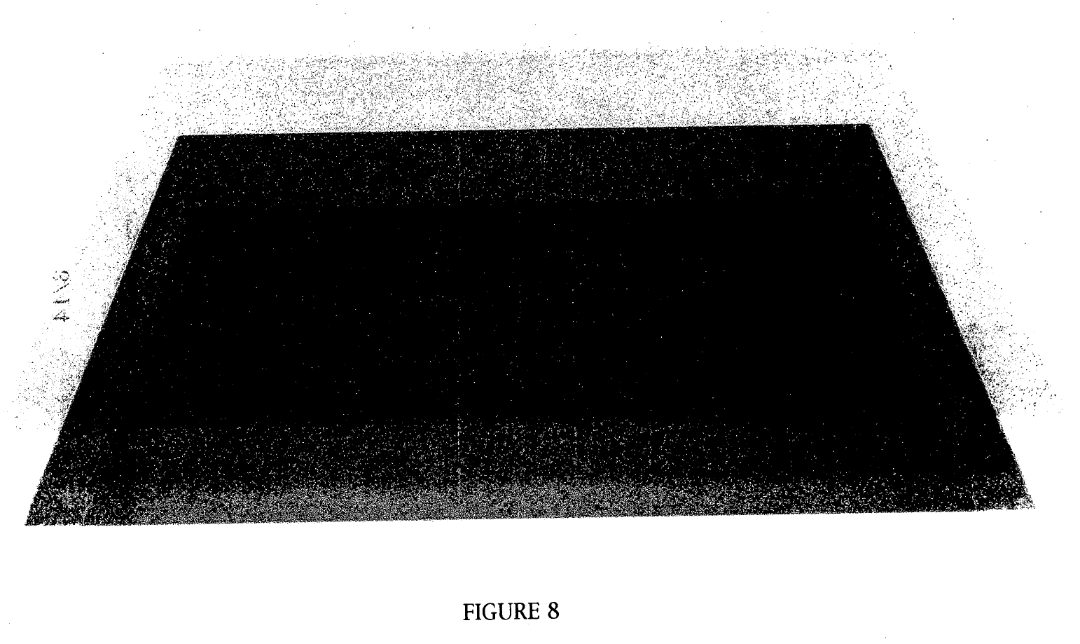

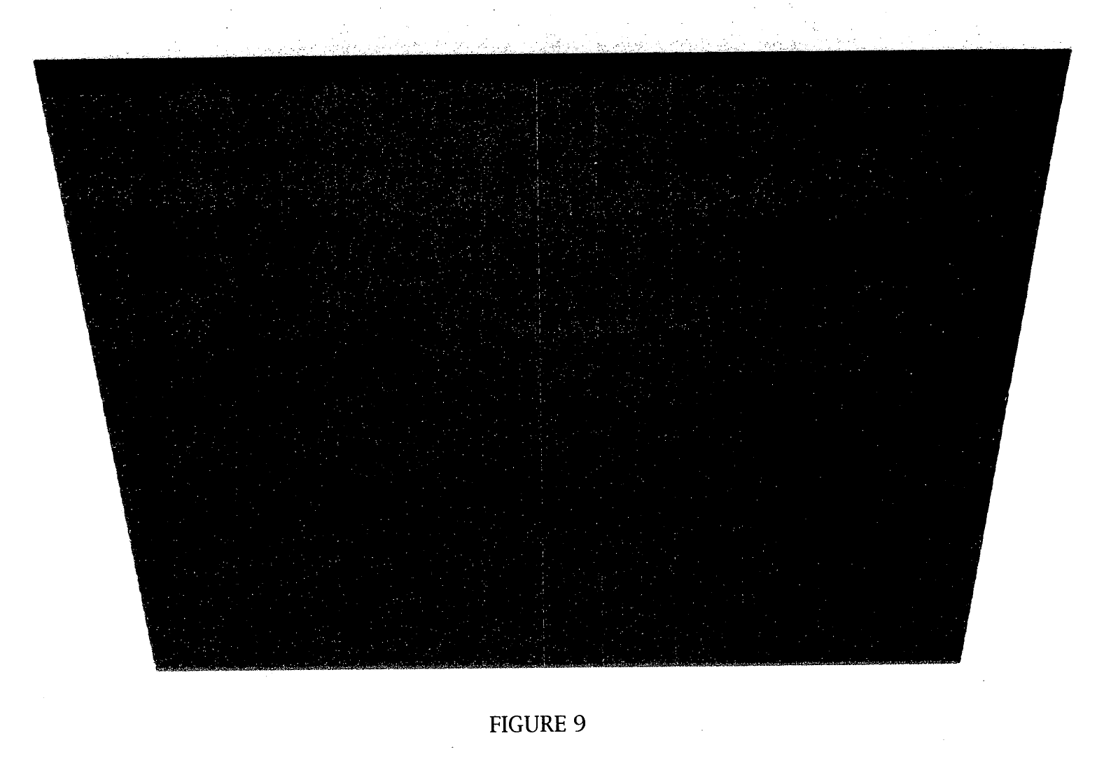

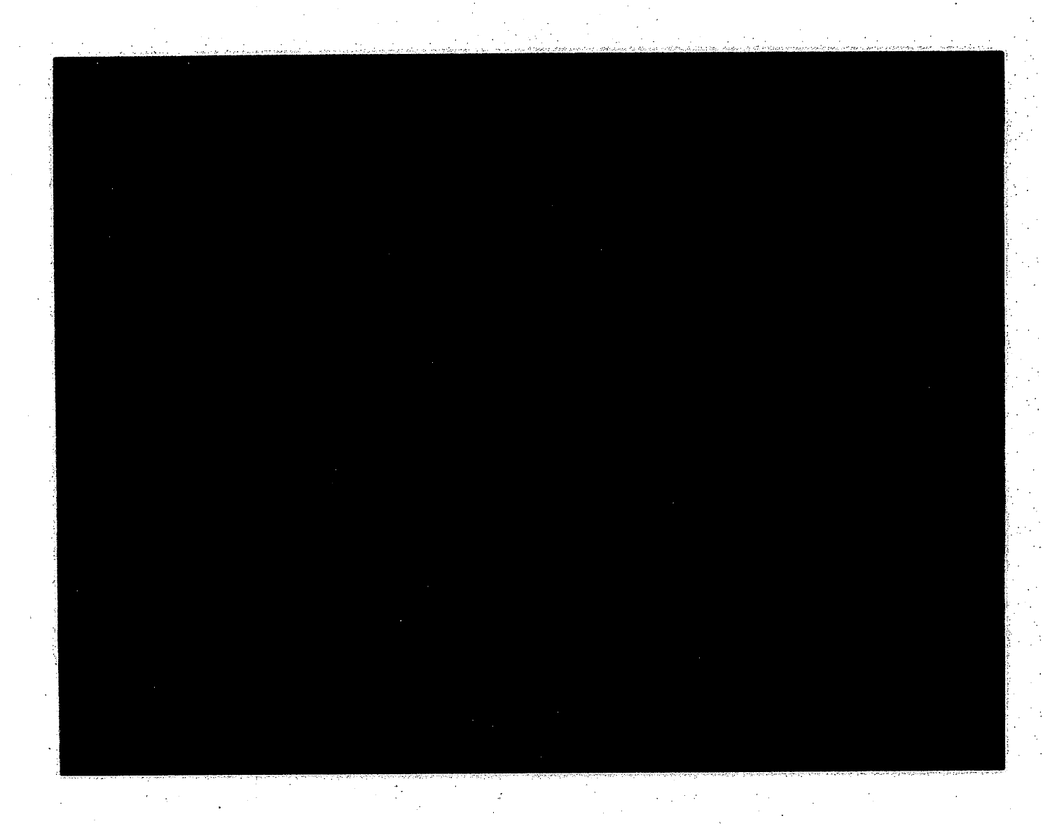

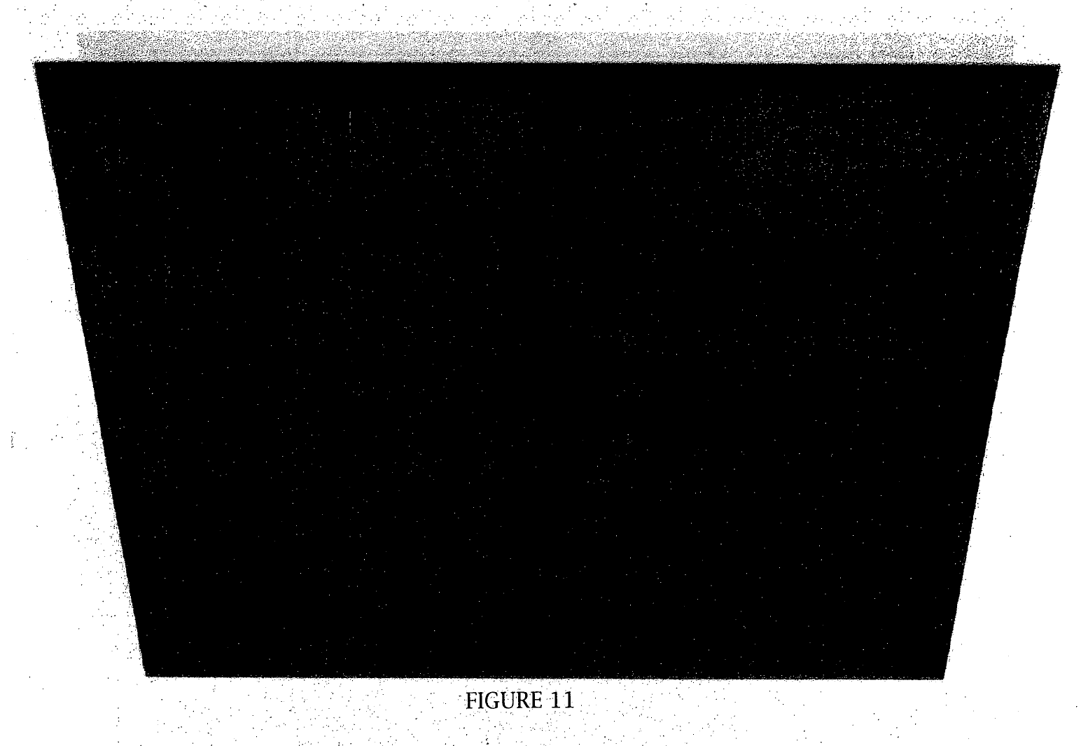

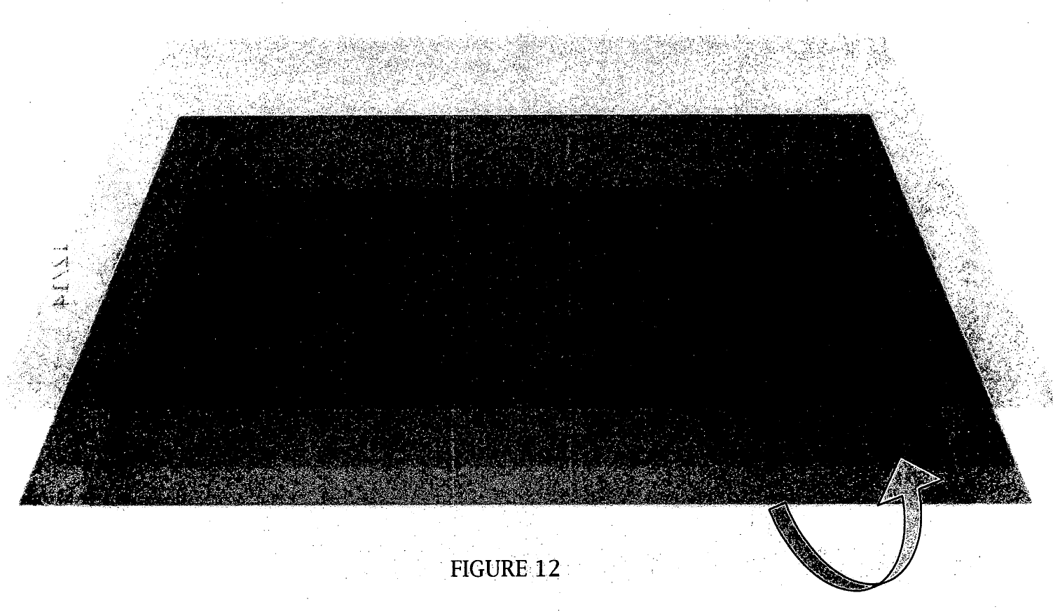

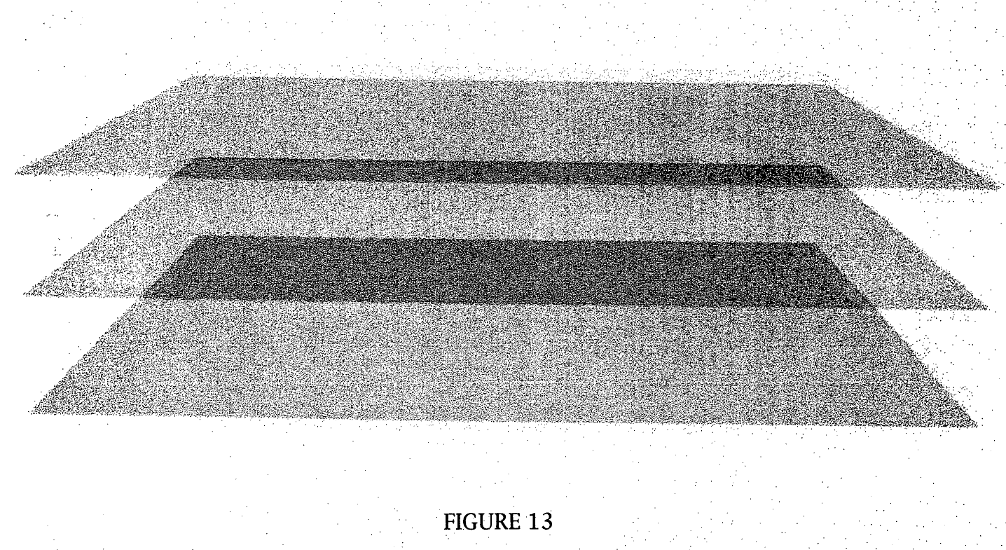

The display visually leads the user through the difficult mental task of spatial rotation. This is particularly true when going from 2D to 3D or back. In FIGS. 7 through 13, the transfer from 2D in FIG. 7 is seen to rotate continuously to a changing orientation in FIG. 8. through the beginning appearance of 3D in FIG. 9, to full 3D in FIG. 10. FIG. 11 shows the beginning of rotation from 3D back to 2D, shown partly in FIG. 12 and completely in FIG. 13.

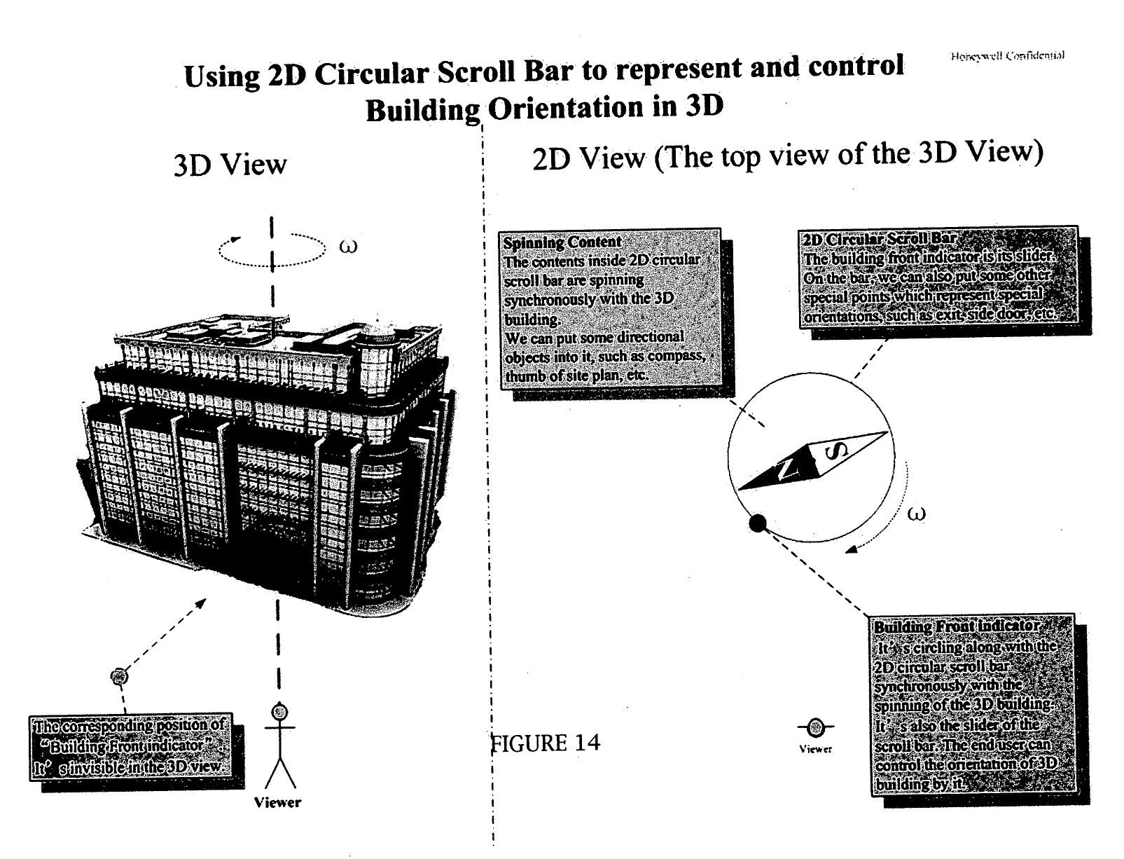

FIG. 14 illustrates a structure in 3d which is distinctive and quite large. Various towers and balconies make the view quite complicated. The user, shown as a “viewer” in FIG. 12 may want to rotate the display of the building around the axis shown in dash lines in the direction of the arrow. To accomplish this rotation in the past, a user needed VCR controls to move left or right, or to stop the rotation. But VCR controls are best for controlling objects that move in a line, not in a circle. They are not particularly usable for controlling an object that is rotating in a circle. Here in FIG. 12, the circular scroll bar can be used to control the ratio of a structure shown in 3D graphics, moving it around its axis. The scroll bar represents the structure, showing the front of the building as a red dot on the scroll bar. The spinner N/S can be turned by touch or by a mouse control on the display screen of the monitor and rotated about the axis in the position of the arrow by the angle ω to reach the desired direction of observation. The circular scroll bar provides the user a direct control of the 3D structure's rotation. The angular movement of the circular scroll bar around its center maps in a direct proportional manner tot eh angular movement of the three dimensional image around its axis. Thus the user is visually anchored to the front and/or rear of the building and to cardinal directions.

While particular embodiments of the present invention have been illustrated and described, it is not intended to limit the invention, except as defined by the following claims.

1. A system for aiding spatial orientation of displayed graphical models of structures, comprising:
a processor for providing a graphical model of a structure;
a monitor for displaying said graphical model of a structure; and
an input for inputting commands to said processor to selectively display said model as a two dimensional model or a three dimensional model, said input further being adapted to command said processor to display selected features of said structure.

2. The system of claim 1, wherein said selected features are selected from the group consisting of specific areas of said structure, fire hydrants, elevators, smoke detectors, fire detectors, stairways, individuals and physical assets within said structure, and mixtures thereof.

3. The system of claim 1, where processor selectively changes said model between said two dimensional model to said three dimensional model over a noticeable period of time.

4. The system of claim 3, wherein said noticeable period of time is from about less than one to about more than three seconds.

5. The system of claim 1, wherein said input includes a command to highlight one area of said structure.

6. The system of claim 5, wherein said one area is one or more floors or one side of said structure.

7. The system of claim 6, wherein said model portrays said structure in semi-transparent form and said one floor is shown as decreased transparency and the remaining floors are shown with increased transparency.

8. The system of claim 6, wherein said one floor is shown with a wire frame to thereby highlight said one floor.

9. The system of claim 6, wherein said one floor is color tinted to thereby highlight said one floor and associate said floor with some condition or state.

10. The system of claim 1, wherein said entire structure is shown with a wire frame on the exterior corners of said structure.

11. The system of claim 10, wherein said wire frame is rendered in a pale or faded gray color so as to not unduly occlude graphical objects or icons embedded in the 3D graphic of the structure.

12. The system of claim 1, wherein the exterior features of said structure are shown.

13. The system of claim 12, wherein the exterior features are selected from the front door, the roof line, annexes, and mixtures thereon.

14. The system of claim 1, wherein said input includes a circular scroll bar for rotating a three dimensional image of said structure about an axis.

15. The system of claim 14, wherein circular scroll bar contains an indication of the front of the structure and the cardinal direction in which the three dimensional image of said structure is currently oriented, whereby the angular movement of the circular scroll bar around its center maps in a directly proportional manner to the angular movement of the three dimensional image around its axis.

16. A method for aiding spatial orientation of displayed graphical models of structures, comprising:
a processor for providing a graphical model of a structure;
a monitor for displaying said graphical model of a structure; and
an input for inputting commands to said processor to selectively display said model as a two dimensional model or a three dimensional model, said input further being adapted to command said processor to display selected features of said structure.

17. The method of claim 16, wherein said selected features are selected from the group consisting of specific areas of said structure, fire hydrants, elevators, smoke detectors, fire detectors, stairways, individuals and physical assets within said structure, and mixtures thereof.

18. The method of claim 16, where processor selectively changes said model between said two dimensional model to said three dimensional model over a noticeable period of time.

19. The method of claim 18, wherein said noticeable period of time is from about less than one to about more than three seconds.

20. The method of claim 16, wherein said input includes a command to highlight one area of said structure.

21. The method of claim 20, wherein said one area is one or more floors or sides of said structure.

22. The method of claim 21, wherein said model portrays said structure in semi-transparent form and said one or more floors or sides is shown as decreased transparency and the remaining floors are shown with increased transparency.

23. The method of claim 22, wherein said one floor is shown with a wire frame to thereby highlight said one floor.

24. The method of claim 22, wherein said one floor is color tinted to thereby highlight said one or more floors or sides and associate said one or more floors or sides with some condition or state thereon.

25. The method of claim 16, wherein said entire structure is shown with a wire frame on the exterior corners of said structure.

26. The method of claim 25, wherein said wire frame is rendered in a pale or faded gray color so as to not unduly occlude graphical objects or icons embedded in the 3D graphic of the structure.

27. The method of claim 16, wherein the exterior features of said structure are shown.

28. The method of claim 27, wherein the exterior features are selected from the front door, the roof line, annexes, and mixtures thereon.

29. The method of claim 16, wherein said input includes a circular scroll bar for rotating a three dimensional image of said structure about an axis.

30. The method of claim 29, wherein circular scroll bar contains an indication of the front of the structure and the cardinal direction in which the three dimensional image of said structure is currently oriented, whereby the angular movement of the circular scroll bar around its center maps in a directly proportional manner to the angular movement of the three dimensional image around its axis.
